(19) United States
(12) Patent Application Publication
(10) Pub. No.: US 2024/0067294 A1
(43) Pub. Date: Feb. 29, 2024

(54) BICYCLE AND SCOOTER HYBRID

(71) Applicant: Balamurugan DURAISAMY, Scarborough (CA)

(72) Inventor: Balamurugan DURAISAMY, Scarborough (CA)

(21) Appl. No.: 17/823,192

(22) Filed: Aug. 30, 2022

(51) Int. Cl. B62K 3/00; B62K 3/02; B62K 19/02; B62K 19/46; B62M 1/28

(52) U.S. Cl. CPC B62K 3/002; B62K 3/02; B62K 19/02; B62K 19/46; B62M 1/28; B62K 2202/00; B62K 2204/00

(57) ABSTRACT

A bicycle and scooter hybrid is provided. A bicycle and scooter hybrid including a front wheel and a rear wheel separated by a frame. The frame containing a front frame member fused to a top first connection frame member and a lower first connection frame member at a rear midpoint. A middle frame member fused to a top second connection frame member at an upper rear midpoint, a lower second connection frame member fused at a lower rear midpoint, the top first connection frame member fused at an upper front midpoint and the lower first connection frame member fused at a lower front midpoint. A handle fused to a top of the front frame member. A carrier fused to a top of the middle frame member for providing a resting surface and a footrest affixed to a base of the middle frame member.

### FIELD OF THE INVENTION

The present disclosure relates to a bicycle and scooter hybrid, more specifically, but not by way of limitation, more particularly to a combination bicycle scooter for transportation, exercise, and leisure.

### BACKGROUND

Any discussion of the related art throughout the specification should in no way be considered as an admission that such related art is widely known or forms part of common general knowledge in the field.

A bicycle or e-bike driven by a motor or is driven by pedaling in seated position using a handlebar for navigation. Similarly, a scooter or e-scooter is driven using battery or swinging one of leg on road while standing on one leg. Currently, no bicycle scooter combination exists which facilitates bicycle pedaling and scooter leg swinging along with a motorized drive that can be optionally charged by the bicycle pedaling and/or scooter leg swinging from the user.

U.S. Pub. No. 2005/0023793 A1 (Fu) discloses a three-wheel, foot-powered pedal scooter. Shortcomings include an inability to be electrically driven and can't be setup to charge an electric motor.

U.S. Pub. No. 2006/0232040 A1 (Franco) discloses a scooter bike including a scooter frame with a seat and drive mechanism of a bicycle. Shortcomings include an inability to be electrically driven and can't be setup to charge an electric motor.

U.S. Pub. No. 2007/0252356 A1 (Tarlow et al.) discloses a combination bicycle and scooter. Shortcomings include an inability to be electrically driven and can't be setup to charge an electric motor.

U.S. Pub. No. 2013/0161924 A1 (Kim) discloses a kickboard-type bicycle. Shortcomings include an inability to be electrically driven and can't be setup to charge an electric motor.

K.R. Pat. No. 100,763,307 B1 (Yu) discloses a kickboard combined with a bicycle. Shortcomings include an inability to be electrically driven and can't be setup to charge an electric motor.

U.S. Pat. No. 2,723,131 A (McChesney Jr.) discloses a pedal scooter including a movable, pivoted platform can actuate a propelling mechanism. Shortcomings include an inability to be electrically driven and can't be setup to charge an electric motor.

U.S. Pat. No. 6,688,624 B2 (Christensen et al.) discloses a foot pump scooter. Shortcomings include an inability to be electrically driven and can't be setup to charge an electric motor.

U.S. Pat. No. 7,377,532 B2 (Bauce) discloses a pedal drive scooter with an actuating surface to convert reciprocating motion into rotatory motion onto one of the wheels. Shortcomings include an inability to be electrically driven and can't be setup to charge an electric motor.

U.S. Pat. No. 7,621,547 B1 (Fan) discloses an occupant-pedaled drive mechanism for scooter including a pivotally secured pedal to drive the scooter to move. Shortcomings include an inability to operate the drive with a single user, can't be electrically driven and can't be setup to charge an electric motor.

U.S. Pat. No. 7,891,685 B2 (Fan) discloses a scooter driving structure including a step member to drive the scooter to move. Shortcomings include an inability to be electrically driven and can't be setup to charge an electric motor.

All documents cited herein are incorporated by reference.

It is clear that there exists a need for a bicycle and scooter hybrid for transportation, exercise and leisure. There is need for a lightweight, compact combination bicycle and scooter that is stored with ease, can be manually or electrically driven, can be optionally setup to charge an electric motor.

### BRIEF SUMMARY

It is an object of the invention to provide a bicycle and scooter hybrid.

In accordance with an aspect of the invention, there is provided a bicycle and scooter hybrid for providing transportation, facilitating exercise and for leisurely activity comprising a front wheel and a rear wheel separated by a frame, the frame comprising a front frame member fused to a top first connection frame member and a lower first connection frame member at a rear midpoint of the front frame member. A middle frame member fused to a top second connection frame member at an upper rear midpoint of the middle frame member and a lower second connection frame member fused at a lower rear midpoint of the middle frame member, the top first connection frame member fused at an upper front midpoint of the middle frame member and the lower first connection frame member fused at a lower front midpoint of the middle frame member. A handle fused to a top of the front frame member. A carrier fused to a top of the middle frame member for providing a resting surface and a footrest affixed to a base of the middle frame member, wherein the front wheel is affixed to a base of the front frame member and the top second connection frame member and the lower second connection frame member a

In accordance with an embodiment of the invention, a peg is affixed at a midpoint of the lower second connection frame member.

In accordance with an embodiment of the invention, the frame is composed of durable and lightweight material.

In accordance with an embodiment of the invention, the formation of the top first connection frame member and the lower first connection frame member in between the front frame member and the middle frame member is a fork shaped.

In accordance with an embodiment of the invention, the formation of the top second connection frame member and the lower second connection frame member in between the middle frame member and the connection plate is a fork shaped.

In accordance with an embodiment of the invention, an electrical motor is coupled to the front wheel to rotate the front wheel and provide electric drive for the bicycle and scooter hybrid.

In accordance with an embodiment of the invention, the electric motor is optionally switched to charging mode such that manual operation of the bicycle and scooter hybrid is harnessed for charging the electric motor.

In accordance with an embodiment of the invention, further comprising a swing crank affixed to a mounting plate via a plurality of fasteners, the mounting plate coupled to the connection plate and the rear wheel, a swing pedal rotatably coupled to the swing crank via a first pedal arm such that the swing pedal has a pendulum swing about the swing crank, a crank mount affixed to the top first connection frame member and an offset pedal affixed to the crank mount via the plurality of fasteners, coupled to a first gear coupled to a first chain and coupled to the swing pedal via a second pedal arm such that the pendulum swinging of the swing pedal is transferred to the offset pedal to rotate the first gear, wherein the first gear and the first chain coupled to the rear wheel to drive rotation of the rear wheel.

In accordance with an embodiment of the invention, a second gear is coupled to the first gear is optionally coupled to the first chain.

In accordance with an embodiment of the invention, the electrical motor is optionally coupled to the second gear via a second chain to rotate the rear wheel and provide electric drive for the bicycle and scooter hybrid.

In accordance with an embodiment of the invention, an electrical motor affixed to the top first connection frame member and the lower first connection frame member.

In accordance with an embodiment of the invention, the electrical motor is optionally coupled to the second gear and chain to rotate the rear wheel and provide electric drive for the bicycle and scooter hybrid.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

In the figures, embodiments are illustrated by way of example. It is to be expressly understood that the description and figures are only for the purpose of illustration and as an aid to understanding.

Embodiments will now be described, by way of example only, with reference to the attached figures, wherein the figures:

FIG. 1A illustrates an aspect of the subject matter in accordance with one embodiment.

FIG. 1B illustrates an aspect of the subject matter in accordance with one embodiment.

FIG. 2A illustrates an aspect of the subject matter in accordance with one embodiment.

FIG. 2B illustrates an aspect of the subject matter in accordance with one embodiment.

FIG. 2C illustrates an aspect of the subject matter in accordance with one embodiment.

FIG. 3A illustrates an aspect of the subject matter in accordance with one embodiment.

FIG. 3B illustrates an aspect of the subject matter in accordance with one embodiment.

FIG. 4A illustrates an aspect of the subject matter in accordance with one embodiment.

FIG. 4B illustrates an aspect of the subject matter in accordance with one embodiment.

FIG. 5A illustrates an aspect of the subject matter in accordance with one embodiment.

FIG. 5B illustrates an aspect of the subject matter in accordance with one embodiment.

### DETAILED DESCRIPTION

The details of one or more embodiments of the subject matter of this specification are set forth in the accompanying drawings and the description below. Other features, aspects, and advantages of the subject matter will become apparent from the description, the drawings, and the claims.

Like reference numbers and designations in the various drawings indicate like elements.

The disclosure proposes a bicycle and scooter hybrid for transportation, exercise, and leisure activity that overcomes disadvantages inherent in the existing bicycles and scooters. The present invention provides a lightweight, compact combination bicycle and scooter that may be used to charge an electric motor, be driven manually or electrically, and can be stored with ease. As such, the general purpose of the present invention, which will be described subsequently in greater detail, is to provide a new and improved bicycle and scooter hybrid for transportation, exercise and leisure, which provides the advantages and overcomes the aforementioned disadvantages.

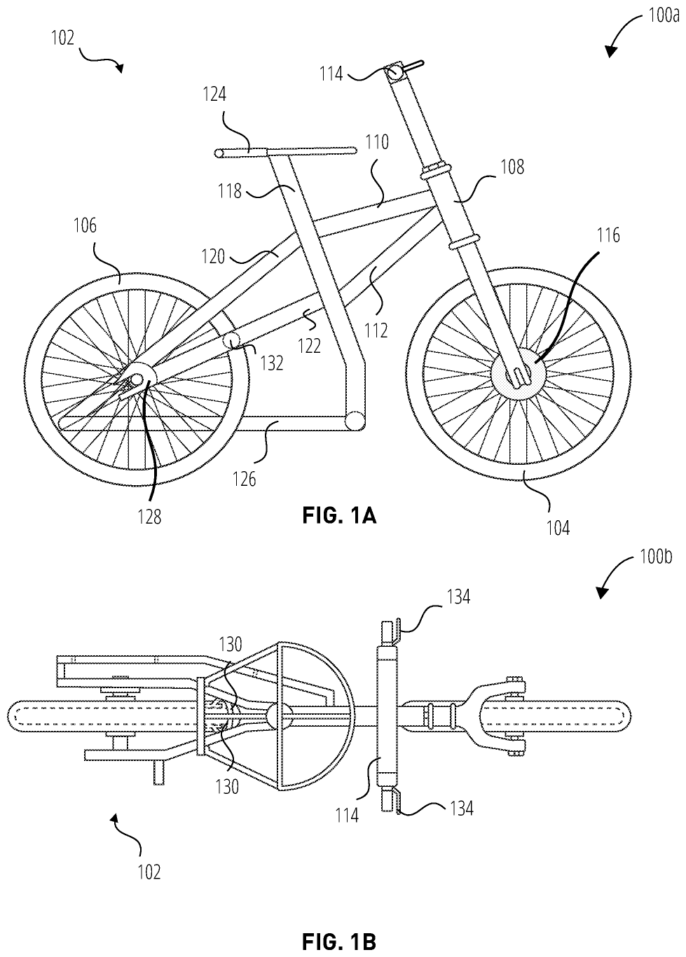

FIG. 1A illustrates a side view 100a of a bicycle and scooter hybrid 102, according to some embodiments. The bicycle and scooter hybrid is shown with a front wheel 104 and a rear wheel 106 separated by the frame. The frame of the bicycle and scooter hybrid comprises a front frame member 108 fused to a top first connection frame member 110 and a lower first connection frame member 112 at a rear midpoint of the front frame member 108. A handle 114 is fused to the top of the front frame member 108 and the front wheel 104 is affixed to the base of the front frame member 108. In some embodiments, an electric motor 116 is coupled to the front wheel 104 for providing an electric drive. In some embodiments, the electric motor 116 can be optionally switched to a charging mode so that the manual operation of the bicycle and scooter hybrid can be harnessed for charging the electric motor 116.

The frame further comprises a middle frame member 118 which is fused to a top second connection frame member 120 at an upper rear midpoint of the middle frame member 118, a lower second connection frame member 122 at a lower rear midpoint of the middle frame member 118, the top first connection frame member 110 at an upper front midpoint of the middle frame member 118, the lower first connection frame member 112 at a lower front midpoint of the middle frame member 118. A carrier 124 is fused to the top of the middle frame member 118 for providing a surface for resting bags and other accessories. A footrest 126 is affixed to the base of the middle frame member 118. In some embodiments, the footrest 126 may be affixed to the right or the left side of the rear wheel 106. The user may stand on the footrest 126 and use one of their legs to push against ground for manual operation of the bicycle and scooter hybrid while holding onto the handle 114. The pushing of the user's leg back and forth against the ground along with the potential employment of the electric motor 116 for rotating the front wheel 104 gives propulsion and force for the front wheel 104 and the rear wheel 106 to move the rider in while they are in an upright position.

The top second connection frame member 120 and the lower second connection frame member 122 are affixed to a connection plate 128 on the footrest 126 side and the rear wheel 106. In some embodiments, a peg 132 is affixed at a midpoint of the lower second connection frame member 122 for providing the user further support. The frame is composed of durable, lightweight material which allows for easy transportation and storage of the bicycle and scooter hybrid. In some embodiments, the formation of the top first connection frame member 110 and the lower first connection frame member 112 in between the front frame member 108 and the middle frame member 118 is a fork shape. In some embodiments, the formation of the top second connection frame member 120 and the lower second connection frame member 122 in between the middle frame member 118 and the connection plate 128 is a fork shape.

FIG. 1B illustrates a top view 100b of a bicycle and scooter hybrid 102, according to some embodiments. In the embodiment shown, two hand brakes 134 are shown attached to the handle 114 with the respective rear brakes 130 coupled to the rear wheel 106 and in other embodiments optionally coupled to the front motor brake. A user may apply one or both of the hand brakes 134 to trigger the rear brakes 130 to prevent further rotation of the rear wheel 106 and optionally to prevent further rotation of the front wheel 104.

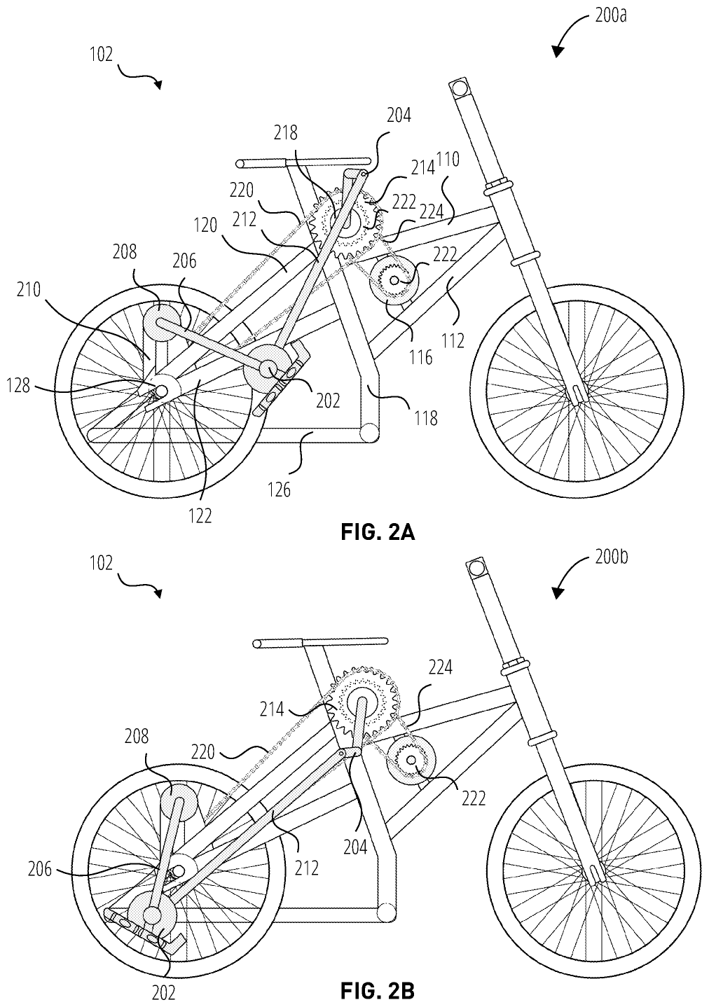

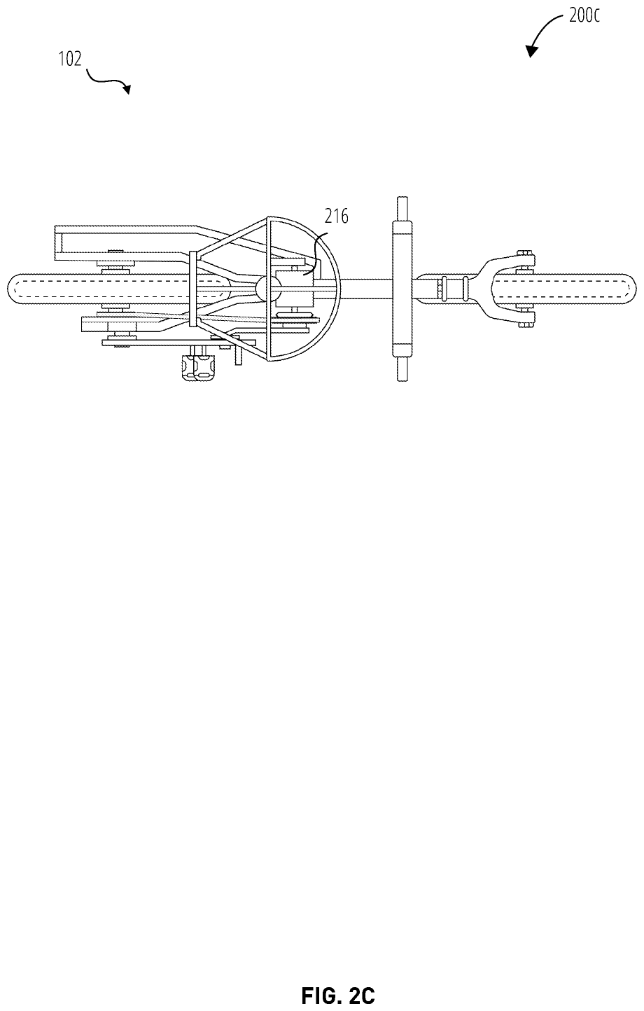

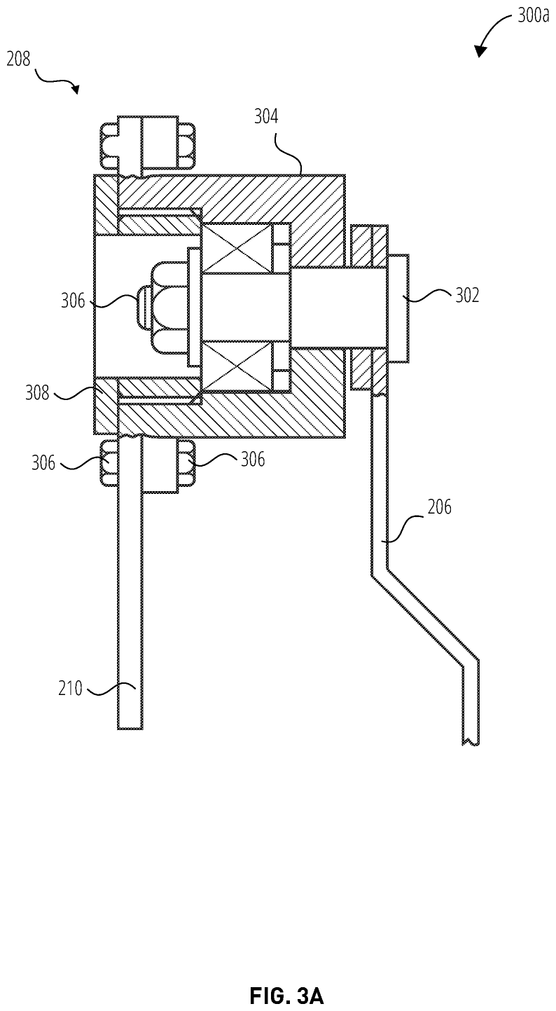

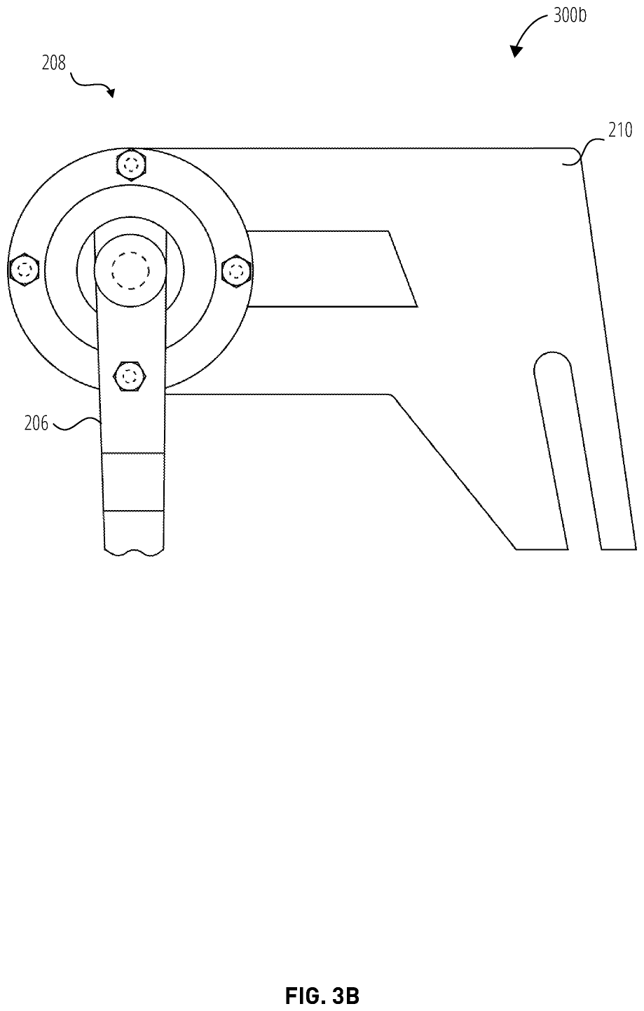

FIG. 2A illustrates a side view 200a of a bicycle and scooter hybrid 102, according to some embodiments. In the embodiment shown, the side of the frame containing the footrest 126 is designed to hold the user's body weight in upright position, while the other side of frame is designed to have the user's leg push and swing a swing pedal 202 and an offset pedal 204. The first pedal arm 206 is shown linking the swing pedal 202 to the swing crank 208, where the swing crank 208 is affixed to a mounting plate 210 that is coupled to the connection plate 128 and the rear wheel 106. One end of the first pedal arm 206 is rotatably coupled to the front face of the swing crank 208 and assembled to the swing pedal 202 such that the swing pedal 202 can swing about the swing crank 208, which is further detailed in FIG. 3A.

The second pedal arm 212 is shown linking the swing pedal 202 to the offset pedal 204, where the offset pedal 204 is coupled to a first gear 214 via a crank mount 216 (shown in FIG. 2C) and a crankset 218. The crank mount 216 is fused at the intersection of the upper front midpoint of the middle frame member 118 and the top of the rear end of the top first connection frame member 110. One end of the second pedal arm 212 is assembled to the rear face of the swing pedal 202 and the other end of the second pedal arm 212 is assembled to the offset pedal 204 such that the rotation of the offset pedal 204 follows the pendulum swinging of the swing pedal 202 and the force of rotating the swing pedal 202 is transfer to the offset pedal 204 to rotate the first gear 214.

The first gear 214 is coupled to a first chain 220, which is further coupled to the rear wheel 106 to drive rotation of the rear wheel 106. In some embodiments, a second gear 222 is coupled to the first gear 214 and is optionally coupled to the first chain 220. In some embodiments, an electrical electric motor 116 is coupled to the front wheel 104 to rotate the front wheel 104 and provide an electric drive for the bicycle and scooter hybrid 102. In some embodiments, the electric motor 116 is affixed in between the top first connection frame member 110 and the lower first connection frame member 112, as shown in FIG. 2A and FIG. 2B. In some embodiments, the electrical electric motor 116 is optionally coupled to a second gear 222 via a second chain 224 to rotate the rear wheel 106 and provide an electric drive for the bicycle and scooter hybrid 102. This is accomplished when the electric motor 116 is turned on and connected to the second chain 224. The second gear 222 will be rotated by the electric motor 116 causing the first gear 214 and first chain 220 to rotate will also rotate the back wheel. In some embodiments, the electrical electric motor 116 is optionally switched to a charging mode such that manual operation of the bicycle and scooter hybrid 102 is harnessed for charging the electric motor 116.

FIG. 2B illustrates a side view 200b of a bicycle and scooter hybrid 102, according to some embodiments. In this embodiment, the swing pedal 202 and the offset pedal 204 are in a pendulum motion, swinging back and forth between their positions in FIG. 2A and FIG. 2B. The second gear 222 is setup with the electric motor 116 to enable the user's pedaling of the swing pedal 202 to charge the electric motor 116.

FIG. 2C illustrates a top view 200c of a bicycle and scooter hybrid 102, according to some embodiments. The crank mount 216 is fused at the intersection of the rear end of the top first connection frame member 110 and the upper front midpoint of the middle frame member 118. In some embodiments the crankset 218 is fused with first gear 214, second gear 222 and may be affixed to the right or the left side crank mount 216.

FIG. 3A illustrates a sectional view 300a of a swing crank 208 from a bicycle and scooter hybrid, according to some embodiments. In the embodiment shown, a shaft 302 locks a first pedal arm 206 to a bearing base 304 of the swing crank 208 via a fastener 306 coupled to the shaft 302 housed between the bearing base 304 and a bearing mount 308. A pair of fasteners 306 are shown locking a mounting plate 210 to the exterior of the bearing base 304.

FIG. 3B illustrates a front view 300b of a swing crank 208 from a bicycle and scooter hybrid, according to some embodiments. In the embodiment shown, the swing crank 208 is affixed to a mounting plate 210.

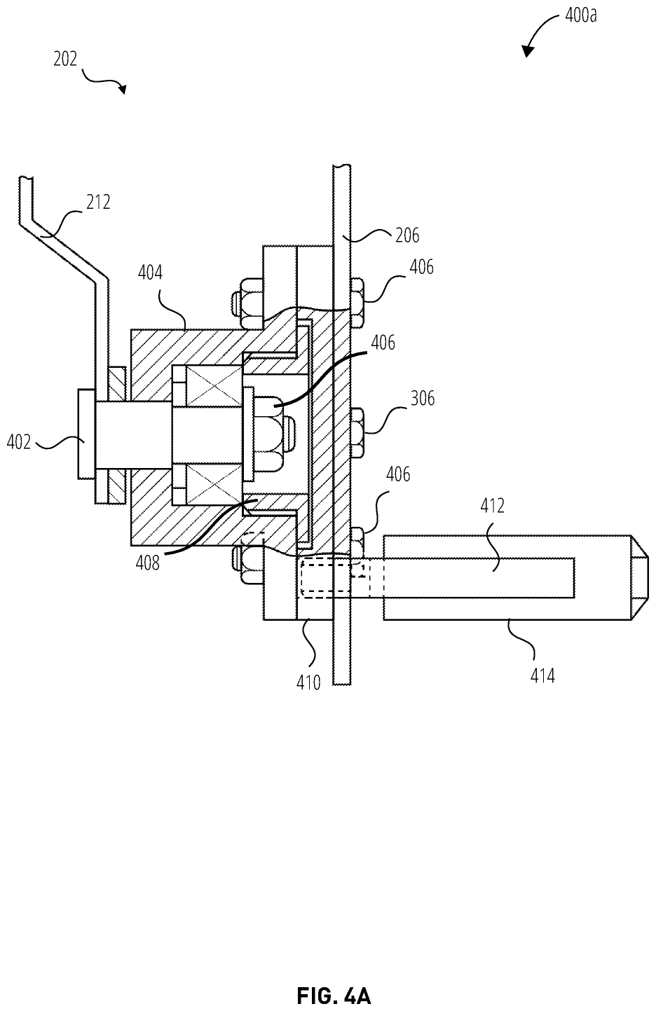

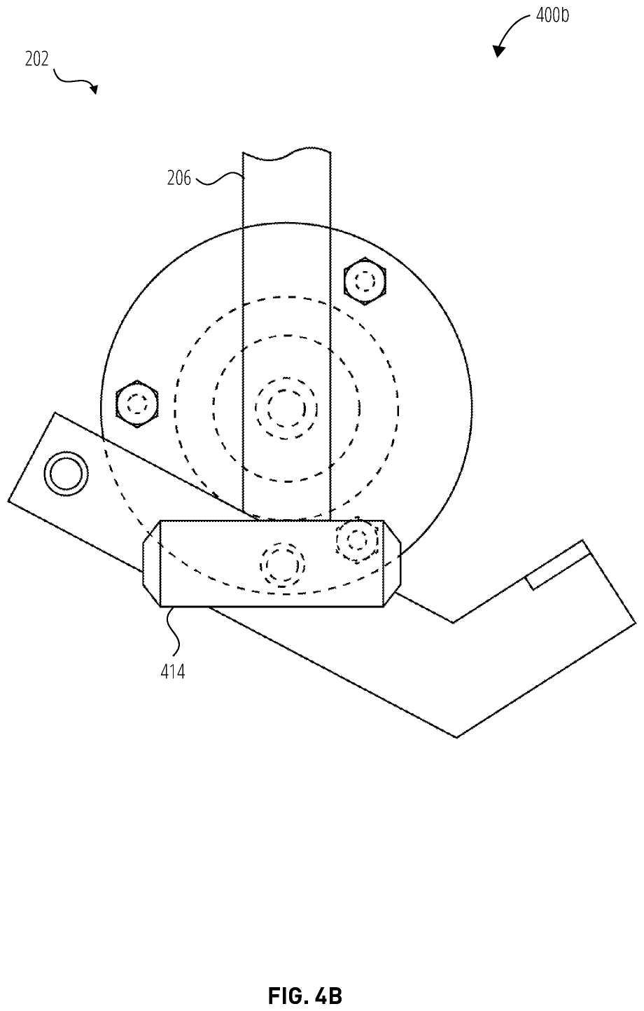

FIG. 4A illustrates a sectional view 400a of a swing pedal 202 from a bicycle and scooter hybrid, according to some embodiments. In the embodiment shown, a shaft 402 locks a second pedal arm 212 to a bearing base 404 of the swing pedal 202 via a fastener 406 coupled to the shaft 402 housed between the bearing base 404 and a bearing mount 408. Several fasteners 406 are shown locking a first pedal arm 206 to a swing pedal mount 410. The swing pedal mount 410 contains a foot extension 412 where the partially protrudes outwards, the exposed portion of the foot extension 412 is coupled to a foot pedal 414.

FIG. 4B illustrates a front view 400b of a swing pedal 202 from a bicycle and scooter hybrid, according to some embodiments. In some embodiments, a pair of foot pedals 414 are fastened to swing pedal mount 410 fused with swing pedal 202 affixed left or right side. The user, in upright position, places one of their feet on the pair of foot pedals 414 and foot extension 412 in a secured manner resulting in the swing of the swing pedal 202 back and forth fastened to swing crank 208.

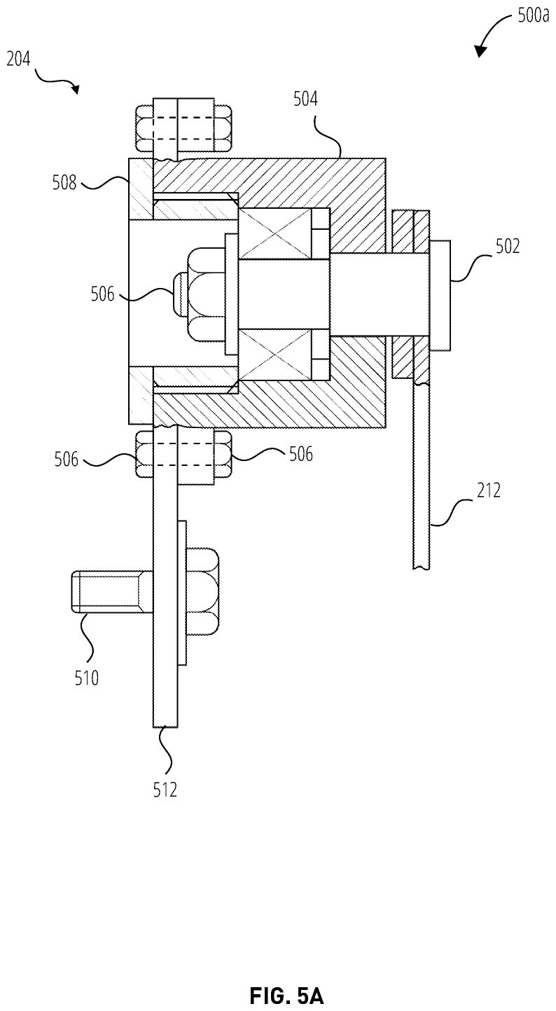

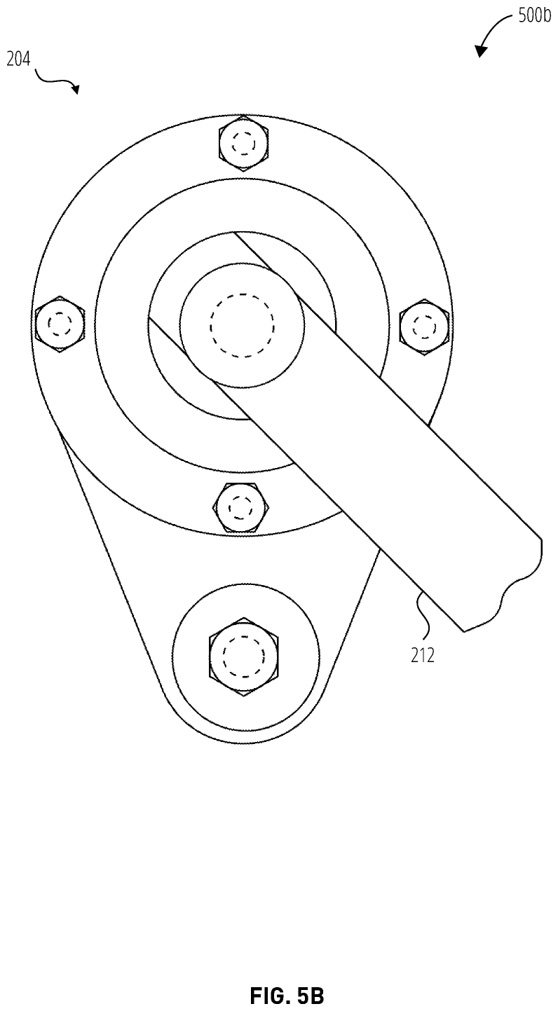

FIG. 5A illustrates a sectional view 500a of an offset pedal 204 from a bicycle and scooter hybrid, according to some embodiments. In the embodiment shown, a bearing shaft 502 locks a second pedal arm 212 to a bearing base 504 of the offset pedal 204 via a fastener 506 coupled to the bearing shaft 502 housed between the bearing base 504 and the bearing mount 508. A pair of fasteners 506 and a left thread fastener 510 are shown locking an offset pedal mount 512 to the exterior of the bearing base 504. A left thread fastener 510 is shown locking the right or the left side of the crank set to the first gear 214.

FIG. 5B illustrates a front view 500b of an offset pedal 204 from a bicycle and scooter hybrid, according to some embodiments. The offset pedal 204 is shown as the connecting link between the crankset 218 and second pedal arm 212, and converts the swing motion of first pedal arm 206 fused to swing crank 208 into a rotary motion of the crankset 218 fused to crank mount 216.

The foregoing descriptions of specific embodiments of the present invention have been presented for purposes of illustration and description. They are not intended to be exhaustive or to limit the invention and method of use to the precise forms disclosed. Obviously, many modifications and variations are possible in light of the above teaching. As can be understood, the examples described above are intended to be exemplary only.

The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient but is intended to cover the application or implementation without departing from the spirit or scope of the claims of the present invention.

The term “connected”, “attached”, “affixed” or “coupled to” may include both direct coupling (in which two elements that are coupled to each other contact each other) and indirect coupling (in which at least one additional element is located between the two elements).

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A bicycle and scooter hybrid for providing transportation, facilitating exercise and for leisurely activity comprising:
a front wheel and a rear wheel separated by a frame, said frame comprising:
a front frame member fused to a top first connection frame member and a lower first connection frame member at a rear midpoint of said front frame member, a middle frame member fused to a top second connection frame member at an upper rear midpoint of said middle frame member and a lower second connection frame member fused at a lower rear midpoint of said middle frame member, said top first connection frame member fused at an upper front midpoint of said middle frame member and said lower first connection frame member fused at a lower front midpoint of said middle frame member;
a handle fused to a top of said front frame member;
a carrier fused to a top of said middle frame member for providing a resting surface; and
a footrest affixed to a base of said middle frame member, wherein said front wheel is affixed to a base of said front frame member and said top second connection frame member and said lower second connection frame member are fused to a connection plate and said rear wheel.

2. The bicycle and scooter hybrid of claim 1, wherein a peg is affixed at a midpoint of said lower second connection frame member.

3. The bicycle and scooter hybrid of claim 1, wherein said frame is composed of durable and lightweight material.

4. The bicycle and scooter hybrid of claim 1, wherein formation of said top first connection frame member and said lower first connection frame member in between said front frame member and said middle frame member is a fork shaped.

5. The bicycle and scooter hybrid of claim 1, wherein formation of said top second connection frame member and said lower second connection frame member in between said middle frame member and said connection plate is a fork shaped.

6. The bicycle and scooter hybrid of claim 1, wherein an electrical motor is coupled to said front wheel to rotate said front wheel and provide electric drive for said bicycle and scooter hybrid.

7. The bicycle and scooter hybrid of claim 6, wherein said electric motor is optionally switched to charging mode such that manual operation of said bicycle and scooter hybrid is harnessed for charging said electric motor.

8. The bicycle and scooter hybrid of claim 1 further comprising:
a swing crank affixed to a mounting plate via a plurality of fasteners, said mounting plate coupled to said connection plate and said rear wheel;
a swing pedal rotatably coupled to said swing crank via a first pedal arm such that said swing pedal has a pendulum swing about said swing crank;
a crank mount affixed to said top first connection frame member; and
an offset pedal affixed to said crank mount via said plurality of fasteners, coupled to a first gear coupled to a first chain and coupled to said swing pedal via a second pedal arm such that said pendulum swinging of said swing pedal is transferred to said offset pedal to rotate said first gear, wherein said first gear and said first chain coupled to said rear wheel to drive rotation of the rear wheel.

9. The bicycle and scooter hybrid of claim 8, wherein a second gear is coupled to said first gear is optionally coupled to said first chain.

10. The bicycle and scooter hybrid of claim 9, wherein an electrical motor is coupled to said front wheel to rotate said front wheel and provide electric drive for said bicycle and scooter hybrid.

11. The bicycle and scooter hybrid of claim 10, wherein said electrical motor is optionally coupled to the second gear via a second chain to rotate said rear wheel and provide electric drive for said bicycle and scooter hybrid.

12. The bicycle and scooter hybrid of claim 11, wherein said electrical motor is optionally switched to a charging mode charged such that manual operation of said bicycle and scooter hybrid is harnessed for charging said electric motor.

13. The bicycle and scooter hybrid of claim 9, wherein an electrical motor affixed to said top first connection frame member and said lower first connection frame member.

14. The bicycle and scooter hybrid of claim 13, wherein said electrical motor is optionally coupled to said second gear and chain to rotate said rear wheel and provide electric drive for said bicycle and scooter hybrid.

15. The bicycle and scooter hybrid of claim 14, wherein said electrical motor is optionally switched to a charging mode charged such that manual operation of said bicycle and scooter hybrid is harnessed for charging said electric motor.
